(19) United States
(12) Patent Application Publication
(10) Pub. No.: US 2026/0263848 A1
(43) Pub. Date: Sep. 10, 2026

(54) Roof Sprinkler Device

(71) Applicant: Michael Sinto, Long Beach, NY (US)

(72) Inventor: Michael Sinto, Long Beach, NY (US)

(21) Appl. No.: 19/275,271

(22) Filed: Jul. 21, 2025

Related U.S. Application Data
(60) Provisional application No. 63/767,723, filed on Mar. 6, 2025.

(51) Int. Cl. A62C 3/02; A62C 35/58; A62C 37/36

(52) U.S. Cl. CPC A62C 3/0214; A62C 35/58; A62C 37/04

(57) ABSTRACT

A roof sprinkler device is disclosed, which is a building fire suppression and prevention sprinkler system, specifically for the exterior of the building. The roof sprinkler device comprises a plurality of sprinkler components that are mounted to the main parts of the building's exterior, such as the roof, gutters, and siding, and connected into the water supply of the structure. The sprinkler components are activated either manually and/or remotely through a mobile application or automatically via smoke and heat detection sensors. The device blends into the exterior of the building and can be the same color scheme to not detract from the home or building's aesthetics. The device suppresses and assists with extinguishing an existing fire and also aids in the prevention of the fire spreading to adjacent structures and the surrounding environment.

### CROSS-REFERENCE TO RELATED APPLICATION

The present application claims priority to, and the benefit of, U.S. Provisional Application No. 63/767,723, which was filed on Mar. 6, 2025, and is incorporated herein by reference in its entirety.

### FIELD OF THE INVENTION

The present invention relates generally to the field of roof sprinkler devices. More specifically, the present invention relates to a fire suppression and spread prevention system that is integrated into a residential or commercial building. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in roof sprinkler devices. Generally, fires and wildfires can occur around residential and commercial structures. If a fire is not put out quickly, it will cause severe damage to the building and the surrounding environment. Home and building owners typically cannot do anything until the fire department arrives.

Accordingly, there is a demand for an improved roof sprinkler device that features sprinklers mounted to different areas of a building's roof that draw water from a nearby water supply. More particularly, there is a demand for a roof sprinkler device that includes manual and automatic activation mechanisms to activate the sprinklers to distribute water to extinguish the flames.

Therefore, there exists a long felt need in the art for a roof sprinkler device that provides users with a fire suppression and spread prevention system that is integrated into a residential or commercial building. There is also a long felt need in the art for a roof sprinkler device that features several sprinklers mounted to different areas of the building like the roof, gutters, siding, etc., that draw water from a nearby water supply. Further, there is a long felt need in the art for a roof sprinkler device that includes manual and automatic activation mechanisms such that if smoke and fire are detected, the sprinklers distribute water to help extinguish the flames. Moreover, there is a long felt need in the art for a device that blends into the exterior of the building to not detract from the home or building's aesthetics. Further, there is a long felt need in the art for a roof sprinkler device that can be in a similar color scheme of the building to blend into the design. Finally, there is a long felt need in the art for a roof sprinkler device that can be remotely controlled via a mobile application.

The subject matter disclosed and claimed herein, in one embodiment thereof, comprises a roof sprinkler device. The device is a building fire suppression and prevention sprinkler system, specifically for the exterior of the building. The roof sprinkler device comprises a plurality of sprinkler components that are mounted to the main parts of the building's exterior, such as the roof, gutters, and siding, and connected into the water supply of the structure. The sprinkler components are activated either manually and/or remotely through a mobile application or automatically via smoke and heat detection sensors. The device blends into the exterior of the building and can be the same color scheme to not detract from the home or building's aesthetics. The device suppresses and assists with extinguishing an existing fire and also aids in the prevention of the fire spreading to adjacent structures and the surrounding environment.

In this manner, the roof sprinkler device of the present invention accomplishes all of the forgoing objectives and provides users with a device that offers fire suppression and spread prevention for residential or commercial buildings. The device is a plurality of sprinkler components secured to an exterior of a building. The device allows for manual or automatic activation of the sprinkler components.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a roof sprinkler device. The device is a building fire suppression and prevention sprinkler system, specifically for the exterior of the building. The roof sprinkler device comprises a plurality of sprinkler components that are mounted to the building's exterior. The sprinkler components are activated either manually or automatically. The device blends into the exterior of the building and acts to extinguish an existing fire and prevent spread.

In one embodiment, the roof sprinkler device suppresses and assists with extinguishing existing fires. Further, the device also aids in preventing fires from spreading to adjacent structures and the surrounding environment. The roof sprinkler device is designed to be positioned on an exterior of a building and is activated to quickly put out a fire, as needed. The device prevents users from having to wait around for the fire department to arrive while their building is burning.

In one embodiment, the roof sprinkler device provides users with a fire suppression and spread prevention device that is integrated into a residential or commercial building, or any other suitable structure as is known in the art. The device can be integrated into the exterior of any building, depending on the needs and/or wants of a user. Typically, the device is integrated into the exterior of a residential house and/or barn or other out-building or a commercial barn or out-building.

In one embodiment, the roof sprinkler device comprises a plurality of sprinkler components that are mounted to the main parts of the building's exterior. The plurality of sprinkler components are mounted to any suitable exterior position on a building, such as the roof, gutters, and siding, etc. The sprinkler components are spaced apart at regularly even intervals to cover a large amount of the building's exterior surface area with water, when needed.

In one embodiment, the plurality of sprinkler components each comprise any suitable components of a conventional sprinkler, such as a controller, pipes, valves, sprinkler heads, and a backflow preventer. These components work together to deliver water to the exterior of the building via the sprinkler components. Specifically, the controller acts to control all of the sprinkler components for watering times and duration and allows for activation (both manual and automatic) of the sprinkler components. The pipes carry water from a water source to the sprinkler heads. The sprinkler heads distribute the water and can have different spray patterns and/or coverage areas. The backflow preventer prevents water from flowing back into the main water supply, protecting it from contamination. Any other suitable components as is known in the art can be included, depending on the needs and/or wants of a user, such as a valve box for housing the control valves of the sprinkler components for easy access, a water meter for measuring the amount of water used, a pressure regulator for maintaining a consistent water pressure throughout the device, and a master valve for controlling the overall water flow to the entire sprinkler device.

In one embodiment, the plurality of sprinkler components are connected into a water source. The water source can be a well, a pond, the local water supply, or the water supply of the building the device is attached to, etc., or any other suitable water supply within the near vicinity that is capable of providing enough water for the plurality of sprinkler components to work properly. As stated supra, the pipes carry water from the water source to the sprinkler heads of the sprinkler components to be distributed, as needed. Further, the backflow preventer prevents water from the pipes from flowing back into the water supply, preventing contamination.

In one embodiment, the plurality of sprinkler components are activated either manually or automatically. Specifically, the plurality of sprinkler components are activated manually via a user accessing the controller of the sprinkler components to manually turn on or off the device, as needed.

In one embodiment, the plurality of sprinkler components each comprise smoke and/or heat detection sensors which act to detect smoke and/or heat to automatically activate the plurality of sprinkler components to distribute water. The smoke and/or heat detection sensors can be any suitable conventional sensors known in the art, which detect smoke and/or heat.

In one embodiment, the roof sprinkler device can be remotely activated through a mobile application. Specifically, the roof sprinkler device includes a wireless communications module and additional sensors which would allow the device to pair with a mobile application on a smart device. Once paired, a user could control the roof sprinkler device via the mobile application.

In one embodiment, the roof sprinkler device is configured to blend into the exterior of the building so as not to detract from the building's aesthetics. Specifically, the device can be the same color scheme and/or concealed under a roof structure, such as an eaves vent or gutter cover, etc., so as not to be easily seen from the ground. This allows the device to not detract from the home or building's aesthetics, while still functioning as a fire suppression sprinkler device.

In yet another embodiment, the roof sprinkler device comprises a plurality of indicia.

In yet another embodiment, a method of suppressing and extinguishing an existing fire is disclosed. The method includes the steps of providing a roof sprinkler device comprising a plurality of sprinkler components. The method also comprises securing the plurality of sprinkler components to an exterior of a building, such as to the roof, gutters, and siding. Further, the method comprises connecting the plurality of sprinkler components into a water supply of the building. The method also comprises manually, remotely via a mobile application, or automatically via sensors, activating the plurality of sprinkler components. Finally, the method comprises suppressing and extinguishing an existing fire via the plurality of sprinkler components.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the roof sprinkler device of the present invention in accordance with the disclosed architecture;

FIG. 2 illustrates a perspective view of one embodiment of the roof sprinkler device of the present invention showing the device in use in accordance with the disclosed architecture;

FIG. 3 illustrates a perspective view of one embodiment of the roof sprinkler device of the present invention showing the device in use to suppress flames in accordance with the disclosed architecture;

FIG. 4 illustrates a perspective view of one embodiment of the roof sprinkler device of the present invention showing the sprinkler components integrated into a roof of a building in accordance with the disclosed architecture;

FIG. 5 illustrates a perspective view of one embodiment of the roof sprinkler device of the present invention showing the sprinkler components integrated into the gutters of a building in accordance with the disclosed architecture; and

FIG. 6 illustrates a flowchart showing the method of suppressing and extinguishing an existing fire in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a roof sprinkler device that provides users with a fire suppression and spread prevention system that is integrated into a residential or commercial building. There is also a long felt need in the art for a roof sprinkler device that features several sprinklers mounted to different areas of the building like the roof, gutters, siding, etc., that draw water from a nearby water supply. Further, there is a long felt need in the art for a roof sprinkler device that includes manual and automatic activation mechanisms such that if smoke and fire are detected, the sprinklers distribute water to help extinguish the flames. Moreover, there is a long felt need in the art for a device that blends into the exterior of the building to not detract from the home or building's aesthetics. Further, there is a long felt need in the art for a roof sprinkler device that can be in a similar color scheme of the building to blend into the design. Finally, there is a long felt need in the art for a roof sprinkler device that can be remotely controlled via a mobile application.

The present invention, in one exemplary embodiment, is a novel roof sprinkler device. The roof sprinkler device comprises a plurality of sprinkler components that are mounted to the main parts of the building's exterior, such as the roof, gutters, and siding, and connected into the water supply of the structure. The sprinkler components are activated either manually and/or remotely through a mobile application or automatically via smoke and heat detection sensors. The device blends into the exterior of the building and can have the same color scheme to not detract from the home or building's aesthetics. The device suppresses and assists with extinguishing an existing fire and also aids in the prevention of the fire spreading to adjacent structures and the surrounding environment. The present invention also includes a novel method of suppressing and extinguishing an existing fire. The method includes the steps of providing a roof sprinkler device comprising a plurality of sprinkler components. The method also comprises securing the plurality of sprinkler components to an exterior of a building, such as to the roof, gutters, and siding. Further, the method comprises connecting the plurality of sprinkler components into a water supply of the building. The method also comprises manually, remotely via a mobile application, or automatically via sensors, activating the plurality of sprinkler components. Finally, the method comprises suppressing and extinguishing an existing fire via the plurality of sprinkler components.

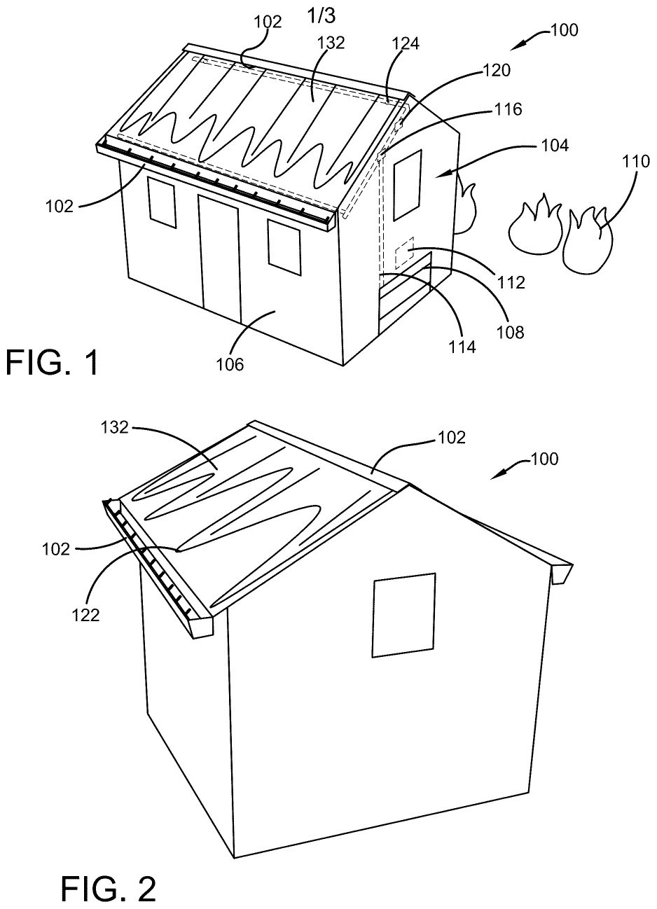

Referring initially to the drawings, FIG. 1 illustrates a perspective view of one embodiment of the roof sprinkler device 100 of the present invention. In the present embodiment, the roof sprinkler device 100 is an improved roof sprinkler device 100 that provides a user with a building fire suppression and prevention sprinkler device for the exterior 106 of a building 104. Specifically, the roof sprinkler device 100 comprises a plurality of sprinkler components 102 secured to an exterior 106 of a building 104 and connected into a water supply 108 of the building 104. The sprinkler components 102 are activated either manually or automatically. The device 100 blends into the exterior 106 of the building 104 and acts to extinguish an existing fire 110 and prevent spread.

Generally, the roof sprinkler device 100 suppresses and assists with extinguishing existing fires 110. Further, the device 100 also aids in preventing fires 110 from spreading to adjacent structures and the surrounding environment. The roof sprinkler device 100 is designed to be positioned on an exterior 106 of a building 104 and is activated to quickly put out a fire 110, as needed. The device 100 prevents users from having to wait around for the fire department to arrive while their building 104 is burning.

Further, the roof sprinkler device 100 provides users with a fire suppression and spread prevention device that is integrated into a residential or commercial building 104, or any other suitable structure as is known in the art. The device 100 can be integrated into the exterior 106 of any building 104, depending on the needs and/or wants of a user. Typically, the device 100 is integrated into the exterior 106 of a residential house and/or barn or other out-building or a commercial barn or out-building (i.e., building 104).

Additionally, the plurality of sprinkler components 102 each comprise any suitable components of a conventional sprinkler, such as a controller 112, pipes 114, valves 116, sprinkler heads 118, and a backflow preventer 120. These components work together to deliver water 122 to the exterior 106 of the building 104 via the sprinkler components 102. Specifically, the controller 112 acts to control all of the sprinkler components 102 for watering times and duration and allows for activation (both manual and automatic) of the sprinkler components 102. The pipes 114 carry water 122 from a water source 108 to the sprinkler heads 118. The sprinkler heads 118 distribute the water 122 and can have different spray patterns and/or coverage areas. The backflow preventer 120 prevents water 122 from flowing back into the main water supply 108, protecting it from contamination. Any other suitable components as is known in the art can be included, depending on the needs and/or wants of a user, such as a valve box for housing the control valves of the sprinkler components 102 for easy access, a water meter for measuring the amount of water 122 used, a pressure regulator for maintaining a consistent water pressure throughout the device 100, and a master valve for controlling the overall water 122 flow to the entire sprinkler device 100.

Furthermore, the plurality of sprinkler components 102 are connected into a water source 108. The water source 108 can be a well, a pond, the local water supply, or the water supply of the building 104 the device 100 is attached to, etc., or any other suitable water supply 108 within the near vicinity that is capable of providing enough water 122 for the plurality of sprinkler components 102 to work properly. As stated supra, the pipes 114 carry water 122 from the water source 108 to the sprinkler heads 118 of the sprinkler components 102 to be distributed, as needed. Further, the backflow preventer 120 prevents water 122 from the pipes 114 from flowing back into the water supply 108, preventing contamination.

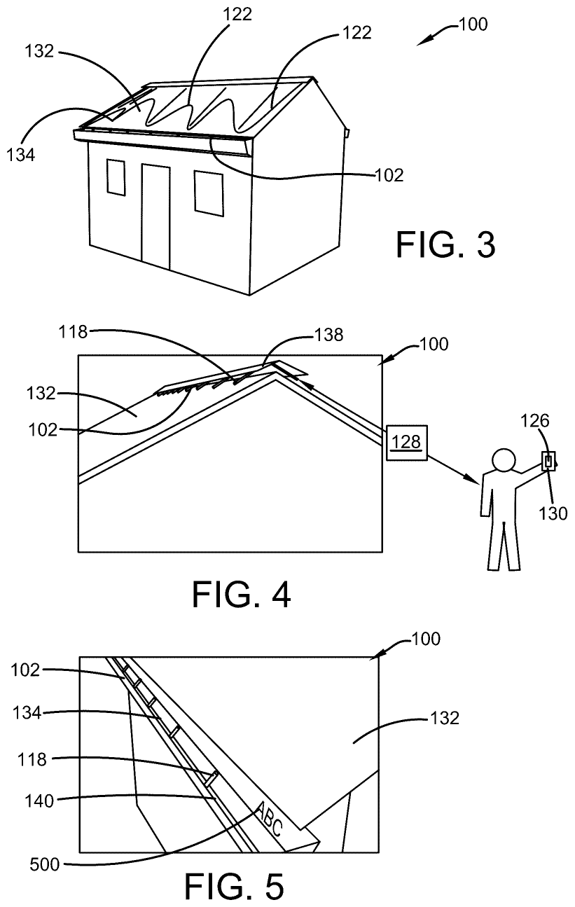

As shown in FIGS. 2-3, the plurality of sprinkler components 102 are activated either manually or automatically. Specifically, the plurality of sprinkler components 102 are activated manually via a user accessing the controller 112 of the sprinkler components 102 to manually turn on or off the device 100, as needed.

In one embodiment, the plurality of sprinkler components 102 each comprise smoke and/or heat detection sensors 124 which act to detect smoke and/or heat to automatically activate the plurality of sprinkler components 102 to distribute water 122. The smoke and/or heat detection sensors 124 can be any suitable conventional sensors known in the art, which detect smoke and/or heat.

In another embodiment, the roof sprinkler device 100 can be remotely activated through a mobile application 126. Specifically, the roof sprinkler device 100 includes a wireless communications module 128 and additional sensors which would allow the device 100 to pair with a mobile application 126 on a smart device 130. Once paired, a user could control the roof sprinkler device 100 via the mobile application 126. The smart device 130 may be a smart phone, a smart tablet, a smart watch, a remote control, or any other device that may have wireless communication capabilities and may be connected to the internet. The smart device 130 may perform any type of wireless communication, including, but not limited to, WIFI, BLUETOOTH, RFID, NFC, etc.

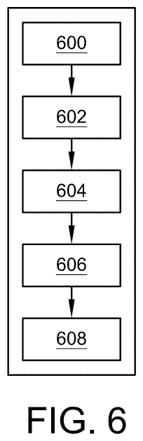

As shown in FIGS. 4-5, the roof sprinkler device 100 comprises a plurality of sprinkler components 102 that are mounted to the main parts of the building's exterior 106. The plurality of sprinkler components 102 are mounted to any suitable exterior position on a building 104, such as the roof 132, gutters 134, and siding 136, etc. The sprinkler components 102 are spaced apart at regularly even intervals to cover a large amount of the building's exterior surface area with water 122, when needed.

Further, the roof sprinkler device 100 is configured to blend into the exterior 106 of the building 104 so as not to detract from the building's aesthetics. Specifically, the device 100 can be the same color scheme and/or concealed under a roof structure, such as an eaves vent 138 or gutter cover 140, etc., so as not to be easily seen from the ground. This allows the device 100 to not detract from the home or building's aesthetics, while still functioning as a fire suppression sprinkler device 100.

In yet another embodiment, the roof sprinkler device 100 comprises a plurality of indicia 500. The sprinkler component 102 of the device 100 may include advertising, a trademark, or other letters, designs, or characters, printed, painted, stamped, or integrated into the sprinkler component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be sprinkler, building, or brand related.

FIG. 6 illustrates a flowchart of the method of suppressing and extinguishing an existing fire. The method includes the steps of at 600, providing a roof sprinkler device comprising a plurality of sprinkler components. The method also comprises at 602, securing the plurality of sprinkler components to an exterior of a building, such as to the roof, gutters, and siding. Further, the method comprises at 604, connecting the plurality of sprinkler components into a water supply of the building. The method also comprises at 606, manually, remotely via a mobile application, or automatically via sensors, activating the plurality of sprinkler components. Finally, the method comprises at 608, suppressing and extinguishing an existing fire via the plurality of sprinkler components.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “roof sprinkler device”, “sprinkler device”, “roof device”, and “device” are interchangeable and refer to the roof sprinkler device 100 of the present invention.

Notwithstanding the foregoing, the roof sprinkler device 100 of the present invention can be of any suitable size and configuration as is known in the art without affecting the overall concept of the invention, provided that it accomplishes the above stated objectives. One of ordinary skill in the art will appreciate that the roof sprinkler device 100 as shown in FIGS. 1-6 is for illustrative purposes only, and that many other sizes and shapes of the roof sprinkler device 100 are well within the scope of the present disclosure. Although the dimensions of the roof sprinkler device 100 are important design parameters for user convenience, the roof sprinkler device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roof sprinkler device that provides a user with a building fire suppression and prevention means, the roof sprinkler device comprising:
a plurality of sprinkler components;
wherein the plurality of sprinkler components are secured to an exterior of a building;
wherein the plurality of sprinkler components are connected to a water supply; and
further wherein the plurality of sprinkler components are activated manually or automatically to distribute water and extinguish an existing fire.

2. The roof sprinkler device of claim 1, wherein the building is a residential or a commercial building.

3. The roof sprinkler device of claim 2, wherein the plurality of sprinkler components each comprise a controller, pipes, valves, sprinkler heads, and a backflow preventer that work together to deliver water to the exterior of the building via the plurality of sprinkler components.

4. The roof sprinkler device of claim 3, wherein the water supply is a well, a pond, a local water supply, or a water supply of the building the plurality of sprinkler components are attached to.

5. The roof sprinkler device of claim 4, wherein the plurality of sprinkler components are activated manually via a user accessing the controller to manually turn on or off the roof sprinkler device, as needed.

6. The roof sprinkler device of claim 5, wherein the plurality of sprinkler components each comprise smoke and/or heat detection sensors which act to detect smoke and/or heat to automatically activate the plurality of sprinkler components to distribute water.

7. The roof sprinkler device of claim 6, wherein the roof sprinkler device can be remotely activated through a mobile application.

8. The roof sprinkler device of claim 7, wherein the roof sprinkler device includes a wireless communications module and additional sensors which would allow the roof sprinkler device to pair with a mobile application on a smart device, once paired, a user could control the roof sprinkler device via the mobile application.

9. The roof sprinkler device of claim 8, wherein the plurality of sprinkler components are mounted to a roof, a gutter, or a siding of the building.

10. The roof sprinkler device of claim 9, wherein the roof sprinkler device is configured to blend into the exterior of the building via being same color scheme or concealed, so as not to detract from a building's aesthetics.

11. A roof sprinkler device that provides a user with a building fire suppression and prevention means, the roof sprinkler device comprising:
a plurality of sprinkler components;
wherein the plurality of sprinkler components are secured to an exterior of a building;
wherein the plurality of sprinkler components are connected to a water supply;
wherein the plurality of sprinkler components are activated manually or automatically to distribute water and extinguish an existing fire;
wherein the plurality of sprinkler components are activated manually via a user accessing a controller to manually turn on or off the roof sprinkler device, as needed;
wherein the plurality of sprinkler components each comprise smoke and/or heat detection sensors which act to detect smoke and/or heat to automatically activate the plurality of sprinkler components to distribute water; and
further wherein the roof sprinkler device can be remotely activated through a mobile application, such that the roof sprinkler device includes a wireless communications module and additional sensors which would allow the roof sprinkler device to pair with a mobile application on a smart device, once paired, a user could control the roof sprinkler device via the mobile application.

12. The roof sprinkler device of claim 11 further comprising a controller to control all of the plurality of sprinkler components for watering times and duration and allows for activation of the plurality of sprinkler components.

13. The roof sprinkler device of claim 12 further comprising pipes which carry water from a water source to sprinkler heads of the plurality of sprinkler components.

14. The roof sprinkler device of claim 13 further comprising sprinkler heads on each of the plurality of sprinkler components to distribute the water and can have different spray patterns or coverage areas.

15. The roof sprinkler device of claim 14 further comprising a backflow preventer to prevent water from flowing back into the water source, protecting it from contamination.

16. The roof sprinkler device of claim 11, wherein the smart device may be a smart phone, a smart tablet, a smart watch, a remote control, or any other device that may have wireless communication capabilities and may be connected to internet.

17. The roof sprinkler device of claim 11 further comprising a plurality of indicia.

18. The roof sprinkler device of claim 11, wherein the plurality of sprinkler components are mounted to a roof, gutters, or a siding of a building.

19. The roof sprinkler device of claim 11, wherein the roof sprinkler device is configured to blend into the exterior of the building via being same color scheme or concealed, so as not to detract from a building's aesthetics.

20. A method of suppressing and extinguishing an existing fire, the method comprising the following steps:
providing a roof sprinkler device comprising a plurality of sprinkler components;
securing the plurality of sprinkler components to an exterior of a building, such as to the roof, gutters, and siding;
connecting the plurality of sprinkler components into a water supply of the building;
manually, remotely via a mobile application, or automatically via sensors, activating the plurality of sprinkler components; and
suppressing and extinguishing an existing fire via the plurality of sprinkler components.
